(19) United States
(12) Patent Application Publication
(10) Pub. No.: US 2019/0089236 A1
(43) Pub. Date: Mar. 21, 2019

(54) LOW-ENERGY-CONSUMPTION AND HIGH-EFFICIENCY CIRCULATING ELECTRIC MOTOR

(71) Applicant: Meng-Theng Wang, New Taipei City (TW)

(72) Inventor: Meng-Theng Wang, New Taipei City (TW)

(21) Appl. No.: 16/132,481

(22) Filed: Sep. 17, 2018

(30) Foreign Application Priority Data
Sep. 19, 2017 (TW) 106213917

(51) Int. Cl. H02K 53/00; H02K 1/06; H02J 7/14

(52) U.S. Cl. CPC H02K 53/00; H02K 25/00; H02J 7/14; H02K 1/06

(57) ABSTRACT

A low-energy-consumption and high-efficiency circulating electric motor that a fan and a circular cylinder-body are disposed on a rotating-shaft and a permanent magnet is disposed on at least one blade of the fan, and at least a permanent magnet is disposed in a frame; wherein the outer diameter surface of the circular cylinder-body is set with a continuous circumferential conductive portion, and a plurality of axial conductive portions are lined in interval and connected with the circumferential conductive portion; wherein a DC generator is connected with the rotating-shaft and a storage battery is electrically connected with a control unit, the DC generator, the circumferential conductive portion, and the DC electromagnet; at the same time, the DC electromagnet intermittently generates a magnetic force by orderly contacting and not contacting the axial conductive portions; and the fan is continuously rotated by the intermittent magnetic force interacting with the permanent magnet.

### (a) TECHNICAL FIELD OF THE INVENTION

The present invention relates to an electric motor, and in particular to a circulating electric motor that can operate with high efficiency and under low-energy consumption by the cooperated combination of the electric force and the magnetic force.

### (b) DESCRIPTION OF THE PRIOR ART

Generally, the motor is driven by alternating current or direct current. Therefore, in addition to part of the electric energy used to drive the rotating shaft to work, another part of the electric energy is lost by mechanical friction and heat, such that the power efficiency is low.

In order to improve the energy utilization efficiency, conventionally it is possible to electrically connect the storage battery and the power recharging device to the motor. And, the generator is driven to generate electricity and recharge into the storage battery for recycling usage while the motor is operating.

However, based on the principle of energy non-extinction, the power that can be recharged is extremely limited, so the efficiency of the electric motor cannot be greatly improved.

### SUMMARY OF THE INVENTION

The present invention is characterized in that a fan and a circular cylinder-body are disposed on a rotating-shaft and a permanent magnet is disposed on at least one blade of the fan, and at least a permanent magnet is disposed in a frame; wherein the outer diameter surface of the circular cylinder-body is set with a continuous circumferential conductive portion, and a plurality of axial conductive portions are lined in interval and connected with the circumferential conductive portion; wherein a DC generator is connected with the rotating-shaft and a storage battery is electrically connected with a control unit, the DC generator, the circumferential conductive portion, and the DC electromagnet; wherein the DC generator is drived by the rotating-shaft to rotate and generate electricity to charge the storage battery when the fan rotates; at the same time, the DC electromagnet intermittently generates a magnetic force by orderly contacting and not contacting the axial conductive portions through the conductive elements; such that the fan is continuously rotated by the intermittent magnetic force interacting with the permanent magnet.

The technical means of the low-energy-consumption and high-efficiency circulating electric motor provided by the present invention comprises: a pedestal having a rotating-shaft; a magnetic driving device having a frame, a fan, and a DC electromagnet; wherein the fan is set on the rotating-shaft to rotate along the rotating-shaft, and at least one blade of the fan is set with at least one permanent magnet; wherein the permanent magnet is set in the frame and corresponding to a path along which the permanent magnet rotates with the fan; an intermittent conductive device having a circular cylinder-body set on the rotating-shaft, wherein the outer diameter surface of the circular cylindrical body is set with a continuous circumferential conductive portion; a plurality of axial conductive portions lined in interval and connected with the circumferential conductive portion; a second gear set on the rotating-shaft; a DC generator having a first gear, wherein the first gear meshes with the second gear; and a storage battery electrically connected to a control unit, the DC generator, and the circumferential conductive portion, and the DC electromagnet; wherein the storage battery is electrically contacted with the circumferential conductive portion through a first conductive element, and the DC electromagnet is electrically contacted with the outer diameter surface of the circular cylinder-body through a second conductive element; wherein the circular cylinder-body and the second gear are rotated via the rotating-shaft when the fan rotates; and then the DC generator is driven to rotate through the first gear to generate power to charge the storage battery; at the same time, the second conductive element orderly contacts and does not contact the axial conductive portions, wherein the DC electromagnet, the intermittent conductive device, and the storage battery are controlled by the control unit to intermittently form a current loop; further, the DC electromagnet intermittently generates a magnetic force which interacts with the permanent magnet to rotate the fan; wherein the permanent magnet is in a state which interrupts the current loop within an angular range of the rotation passing the DC electromagnet; and after the angular range is exceeded, the circuit loop is formed again to constitute cyclic charging and discharging to drive the fan to continuously rotate.

The present invention can respectively set permanent magnets at intervals on the fan blades and the number of the DC electromagnets is equal to the number of the permanent magnets, wherein the number of the axial conductive portions is equal to the number of the permanent magnets, and the number of the axial conductive portions is equal to the number of the permanent magnets and the axial conductive portions are equiangularly arranged on the outer diameter surface of the circular cylinder-body.

The present invention can respectively set a permanent magnet in each blade of the fan, and set with the DC electromagnets corresponding to the number of the permanent magnets; and the number of the axial conductive portions is equal to the number of the permanent magnets and the axial conductive portions are equiangularly arranged on the outer diameter surface of the circular cylinder-body.

With the circulating electric motor provided by the present invention, since the fan simultaneously controls the DC electromagnet to intermittently generate a magnetic force during the continuous operation, and then pushes the fan to rotate at an appropriate time without being reversely interfered by the magnetic force. Therefore, the fan and its rotating-shaft can be driven to rotate with low energy consumption, and the rotation of the fan and the rotating-shaft can drive the generator to generate electric power to recharge the storage battery, thereby achieving the purpose of low-energy-consumption and high-efficiency circulating electric motor.

### BRIEF DESCRIPTION OF THE DRAWINGS

FIG. 1 is a schematic diagram showing the overall structure of the low-energy-consumption and high-efficiency circulating electric motor of the present invention.

FIG. 2 is a schematic diagram showing the structure of the magnetic driving device of the present invention.

FIG. 3 is a schematic plan cross-sectional view showing the structure of the circular cylinder-body of the intermittent conductive device along the 3-3 cross-section of FIG. 1.

FIG. 4 is a schematic plan cross-sectional view showing the structure of the circular cylinder-body of the intermittent conductive device along the 4-4 cross-section of FIG. 1.

FIG. 5 is a schematic diagram showing the intermittent generation of the magnetic force of the DC electromagnet of the present invention relative to the position of the permanent magnet set at the fan.

### DETAILED DESCRIPTION OF THE PREFERRED EMBODIMENTS

The following descriptions are exemplary embodiments only, and are not intended to limit the scope, applicability or configuration of the invention in any way. Rather, the following detailed description provides a convenient illustration for implementing exemplary embodiments of the invention.

Various changes to the described embodiments may be made in the function and arrangement of the elements described without departing from the scope of the invention as set forth in the appended claims.

The foregoing and other aspects, features, and utilities of the present invention will be best understood from the following detailed description of the preferred embodiments when read in conjunction with the accompanying drawings.

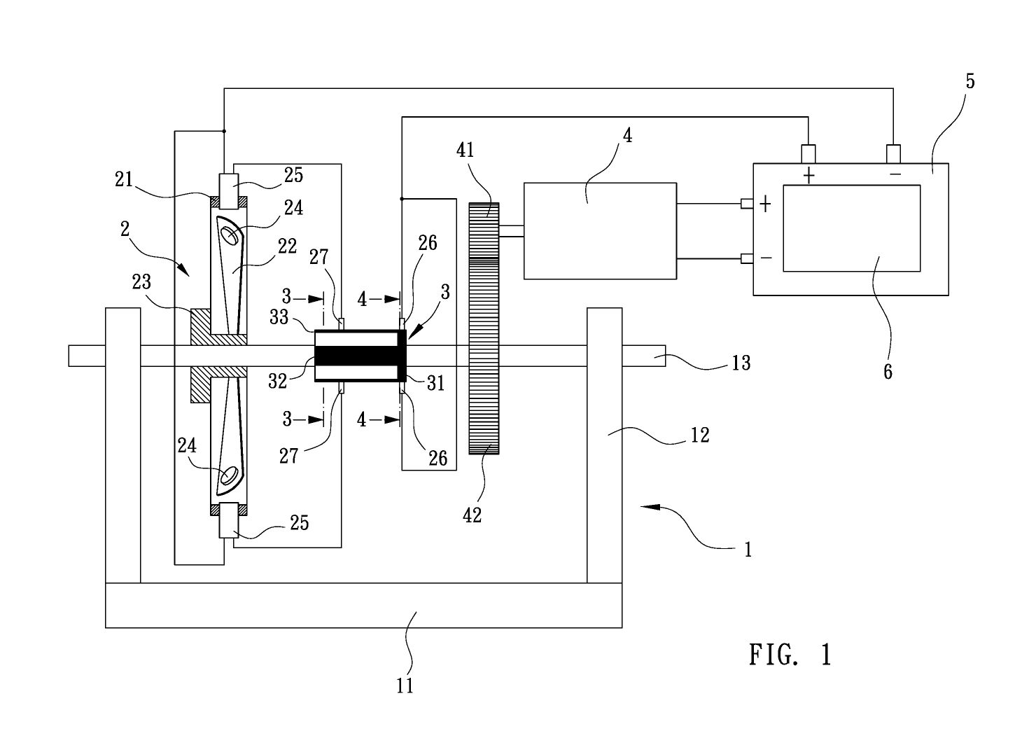

As shown in FIG. 1, the pedestal 1 preferably has a bottom-seat 11, which two stands 12 are erected on two opposite sides of the bottom-seat 11 and a rotating-shaft 13 is movably set between the two stands 12; wherein the embodiment of the present invention may set bearings (not shown in the figure) in the two stands 12 and allow the rotating-shaft 13 to pass through the bearings, so that the rotating-shaft 13 can rotate relative to the stands 12; further, the rotating-shaft 13 can be set horizontally.

The magnetic driving device 2 is a device for driving the rotating-shaft 13 to rotate, which comprises a frame 21, a fan 22 and at least a DC electromagnet 25; wherein the fan 22 has a plurality of blades, and the number of the blades is designed according to the actual needs, which may be a double number or a single number; wherein the fan 22 is set at the rotating-shaft 13 and is rotatable with the rotating-shaft 13, and at least one blade of the fan 22 is set with at least one permanent magnet 24. Preferably, the present invention can further incorporate a flywheel 23 on the side of the axial of the fan 22, which the flywheel 23 has a relatively heavy weight; such that the fan 22 can have a larger rotational inertia through the weight of the flywheel 23.

The frame 21 is preferably formed in a ring shape and surrounds the largest outer diameter of the fan 22; wherein at least one DC electromagnet 25 is set in the frame 21, and the DC electromagnet 25 has an end at which a magnetic force can be generated, and this end toward which of the fan 22 corresponding to the path which the permanent magnet 24 rotates with the fan 22.

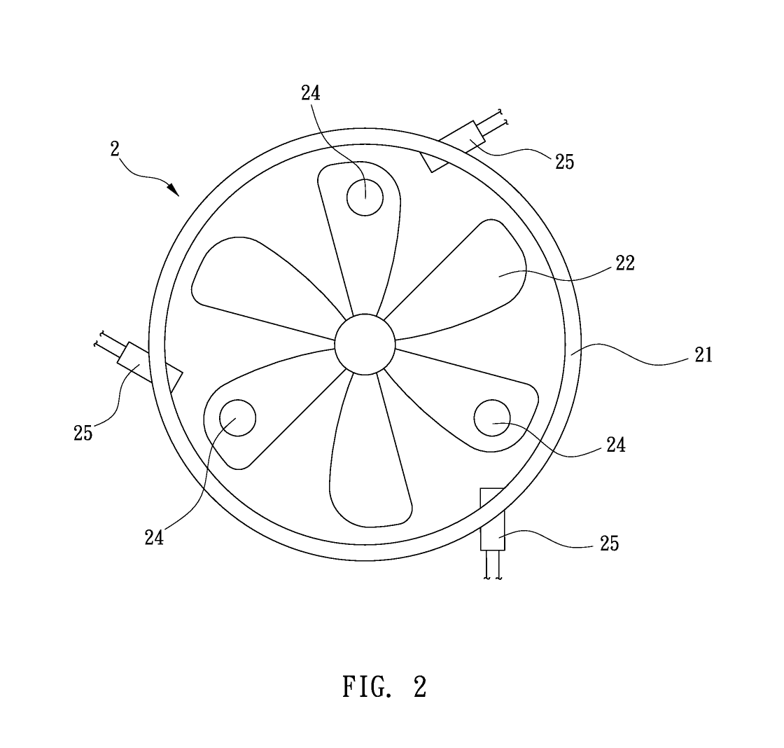

In the present invention, the permanent magnets 24 may be respectively set at a plurality of fan blades of the fan 22, and the number of the plurality of DC electromagnets 25 set in the frame 21 is equal to the number of the permanent magnets 24. For example, as shown in FIG. 2, assuming that the number of blades of the fan 22 is six, the permanent magnets 24 are three and disposed spacedly apart; and the DC electromagnets 25 are also three and are equiangularly disposed in the frame 21, and so on. If the fan blades of the fan 22 are an odd number, the permanent magnets 24 can be placed on the appropriate blades according to the actual need. Alternatively, the permanent magnet 24 can be disposed in each of the blades of the fan 22, and the DC electromagnets 25 corresponding to the number of the permanent magnets 24 are disposed in the frame 21.

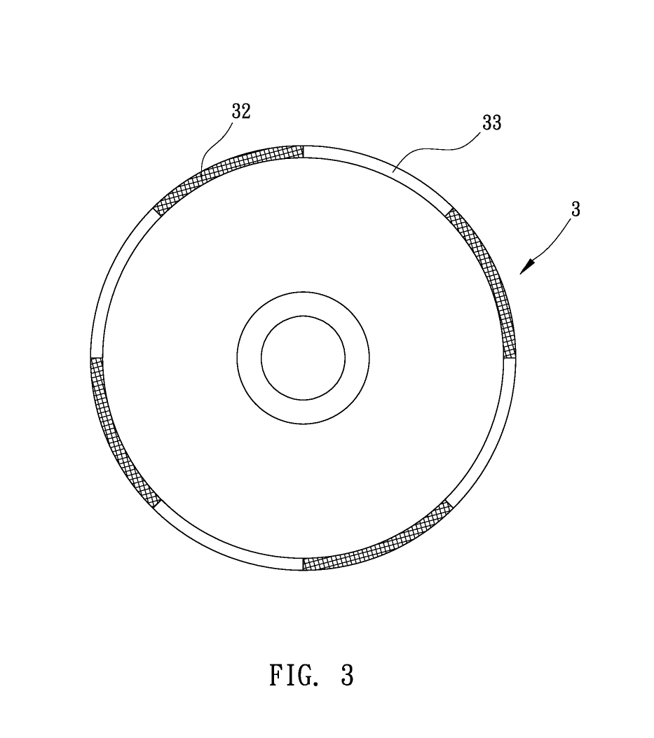

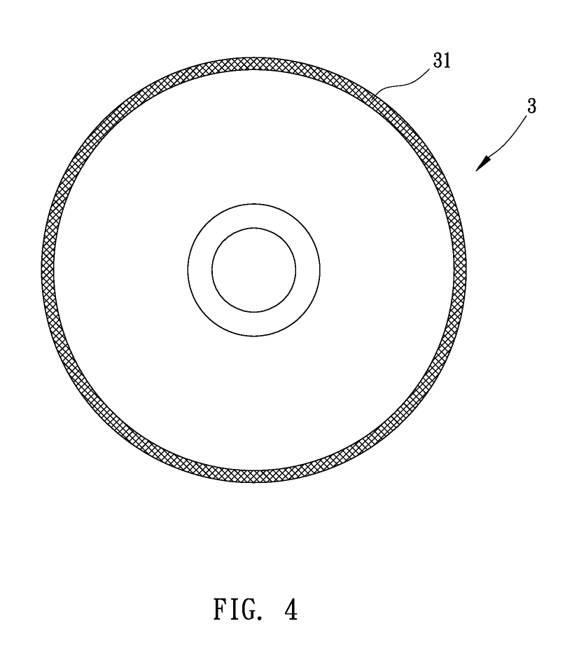

The intermittent conductive device 3 of the present invention is a device for controlling whether the DC electromagnet 25 is electrically energized to generate magnetic force or not; For example, the intermittent conductive device 3 may have a circular cylinder-body fixedly disposed on the rotating-shaft 13, and the outer diameter surface of the circular cylinder-body is set with a continuous circumferential conductive portion 31; and a plurality of axial conductive portions 32 lined in interval and connected to the circumferential conductive portion 31; which an insulating portion 33 is set between the adjacent two axial conductive portions 32. For example, the circumferential conductive portion 31 and the axial conductive portion 32 may be made of a metal material having good electrical conductivity, and the insulating portion 33 may be made of an electrically insulating material such as plastic, rubber, or the like. Preferably, the circumferential conductive portion 31, the axial conductive portion 32 and the insulating portion 33 together constitute the outer diameter surface of the circular cylindrical-body. Furthermore, the number of the axial conductive portions 33 is equal to the number of the permanent magnets 25 and is equiangularly arranged on the outer diameter surface of the circular cylindrical-body (as shown in FIG. 3); and the circumferential conductive portion 31 is continuously surrounding the outer diameter of the circular cylinder (as shown in FIG. 4).

The storage battery 5 of the present invention is electrically connected with a control unit 6 and is electrically connected with the DC generator 4, the circumferential conductive portion 31, and the DC electromagnets 25 by conductive wires; wherein the control unit 6 is a circuit board having a control circuit. For example, the positive electrode of the storage battery 5 can be connected with a conductive wire to electrically contact the circumferential conductive portion 31 through a first conductive element 26; wherein the DC electromagnet 25 can be connected with a conductive wire to contact the axial conductive portion 32 or the insulating portion 33 through a second conductive element 27; further, the negative electrode of the storage battery 5 can be connected to the DC electromagnet 25 via a conductive wire.

The action way of the present invention is explained as follows:

Firstly, the fan 22 is rotated by other power (for example, an additional starter motor, not shown in the figure), and the circular cylinder-body of the intermittent conductive device 3 is drived to rotate synchronously with the second gear 42 through the rotating-shaft 13. The second gear 42 then drives the first gear 41 to drive the DC generator 4 to rotate to generate power, and charges the storage battery 5 via the circuit of the control unit 6. At the same time, the axial conductive portion 32 of the rotating circular cylinder-body and the insulating portion 33 on the rotating circular cylinder-body are in contact with and not in contact with the second conductive element 27 in order, and the circumferential conductive portion 31 is always kept in contact with the first conductive element 26. Accordingly, when the second conductive element 27 contacts the axial conductive portion 32, the intermittent conductive device 3 and the storage battery 5 form a current loop through the DC electromagnet 25 which is controlled by the control unit 6, and thereby causing the DC electromagnet 25 to generate a magnetic force; and then the fan 22 is rotated by the magnetic force interacting with the permanent magnet 24.

When the second conductive element 27 contacts the insulating portion 33, the current circuit is interrupted, so that the DC electromagnet 25 does not generate a magnetic force and the fan 22 is continuously rotated by utilizing the rotational inertia the of the flywheel 23.

The magnetic force interacts with the permanent magnet 24, which means that the DC electromagnet 25 can generate the same magnetic force as the permanent magnet 24, thereby urging the fan 22 to rotate by the repulsive force; or the DC electromagnet 25 can generate different magnetic force with the permanent magnet 24; thereby urging the fan 22 to rotate by the magnetic attraction force.

The present invention utilizes the intermittent conductive device 3 to provide intermittent repulsive force or intermittent attractive force for preventing the fan 22 from being not smoothly operated by the reverse repulsive force or reverse attractive force of the DC electromagnet 25 during continuous operation.

In more detail, after a permanent magnet 24 on the fan 22 is rotated by the pushing of the repulsive force of the DC electromagnet 25 or pulling of the attractive force of the DC electromagnet 25; if the DC electromagnet 25 continues to be electrically energized to have a magnetic force, and when the permanent magnet 24 rotates to approach the next DC electromagnet 25; the repulsion or attraction of the DC electromagnet 25 will stop the fan 22 to continuously rotate.

Therefore, the present invention is designed that the permanent magnet 24 interrupts the current loop state within an angle range which rotates to pass through the DC electromagnet 25; and after this angle range is exceeded, the circuit loop will be formed again to constitute a cyclic charge and discharge to drive the fan rotate continuously.

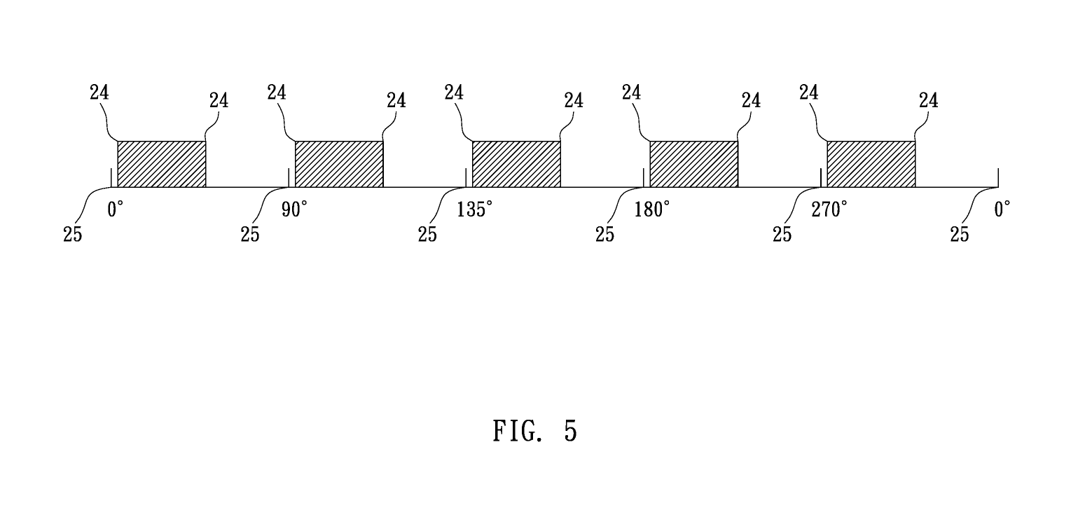

More specifically, as shown in FIG. 5, if it is assumed that four DC electromagnets 25 are disposed on the frame 21 and are arranged at 90 degrees apart; the fan 22 has four blades arranged at 90 degrees apart and one permanent magnet 24 is arranged for each blade. According to the present invention, when the fan 22 rotates, the arrangement of the axial conductive portion 32 of the intermittent conductive device 3 on the circular cylinder can be set, such that when the permanent magnet 24 passes the DC electromagnet 25 by about 2 degrees (or other angles); and then the second conductive element 27 contacts the axial conductive portion 32 to cause the DC electromagnet 25 to be electrically energized to generate a magnetic force. And, after the permanent magnet 24 is rotated to about 47 degrees (or other angles) in this state, then the second conductive element 27 is brought into contact with the insulating portion 33 to be powered off. At this time, the DC electromagnet 25 does not generate a magnetic force, and the fan 22 rotates only by utilizing the rotational inertia of the fan 22 and the flywheel 23. Until the permanent magnet 24 is rotated to about 88 degrees (or other angles), then the second conductive element 27 is brought into contact with the axial conductive portion 32, and the DC electromagnet 25 is electrically energized to generate a magnetic force. And, after the permanent magnet 24 is rotated to about 133 degrees (or other angles) in this state, the second conductive element 27 is brought into contact with the insulating portion 33 to be powered off. At this time, the DC electromagnet 25 does not generate a magnetic force, and the fan 22 rotates only by utilizing the rotational inertia of the fan 22 and the flywheel 23. This cycle can be continuously operated, so that the fan 22 can be continuously rotated; and the rotating-shaft 13 is also continuously rotated, wherein the rotating-shaft 13 can be connected to a power apparatus such as an automobile, a ship, a home electric appliance, or the like.

I claim:

1. A low-energy-consumption and high-efficiency circulating electric motor, which comprises:
a pedestal having a rotating-shaft;
a magnetic driving device having a frame, a fan, and a DC electromagnet; wherein the fan is set on the rotating-shaft and is rotatable along the rotating-shaft; wherein at least one blade of the fan is set with at least one permanent magnet, and the DC electromagnet is set on the frame and corresponded to a path of the permanent magnet rotating with the fan;
an intermittent conductive device having a circular cylinder-body set on the rotating-shaft, wherein the outer diameter surface of the circular cylinder-body is set with a continuous circumferential conductive portion, and a plurality of axial conductive portions are lined in interval and connected to the circumferential conductive portion;
a second gear set on the rotating-shaft;
a DC generator having a first gear; wherein the first gear meshes with the second gear; and
a storage battery electrically connected with a control unit, the DC generator, the circumferential conductive portion, and the DC electromagnet; wherein the storage battery electrically contacts with the circumferential conductive portion through a first conductive element, and the DC electromagnet contacts with the outer diameter surface of the circular cylinder-body through a second conductive element; wherein the circular cylinder-body and the second gear are rotated via the rotating-shaft when the fan rotates; and then the DC generator is driven to rotate through the first gear to generate power to charge the storage battery; at the same time, the second conductive element orderly contacts and does not contact the axial conductive portions, wherein the DC electromagnet, the intermittent conductive device, and the storage battery are controlled by the control unit to intermittently form a current loop; further, the DC electromagnet intermittently generates a magnetic force which interacts with the permanent magnet to rotate the fan; wherein the permanent magnet is in a state which interrupts the current loop within an angular range of the rotation passing the DC electromagnet; and after the angular range is exceeded, the circuit loop is formed again to constitute cyclic charging and discharging to drive the fan to continuously rotate.

2. The low-energy-consumption and high-efficiency circulating electric motor according to claim 1, wherein the fan blades are respectively set with the permanent magnets at intervals, and the number of the DC electromagnets is equal to the number of the permanent magnets; wherein the number of the axial conductive portions is equal to the number of the permanent magnets, and the axial conductive portions are equiangularly arranged on the outer diameter surface of the circular cylinder-body.

3. The low-energy-consumption and high-efficiency circulating electric motor according to claim 2, wherein the permanent magnet is set in each blade of the fan, and the DC electromagnets corresponding to the number of the permanent magnets are set; wherein the number of the axial conductive portions is equal to the number of the permanent magnets, and the axial conductive portions are equiangularly arranged on the outer diameter surface of the circular cylinder-body.

4. The low-energy-consumption and high-efficiency circulating electric motor according to claim 1, wherein the DC electromagnet generates a magnetic force that repels the permanent magnet to push the fan to rotate.

5. The low-energy-consumption and high-efficiency circulating electric motor according to claim 1, wherein the DC electromagnet generates a magnetic force that is attracted to the permanent magnet to pull the fan to rotate.
